(19) United States
(12) Patent Application Publication
(10) Pub. No.: US 2020/0102093 A1
(43) Pub. Date: Apr. 2, 2020

(54) VEHICLE MOUNTED DRONE PORT, DRONE, AND INTEGRATED COMMUNICATION SYSTEM

(71) Applicant: xCraft Enterprises, Inc., Coeur d'Alene, ID (US)

(72) Inventors: Jerry Daniel Claridge, Coeur d'Alene, ID (US); Phil Burks, Tyler, TX (US)

(21) Appl. No.: 16/590,023

(22) Filed: Oct. 1, 2019

Related U.S. Application Data
(60) Provisional application No. 62/739,472, filed on Oct. 1, 2018.

(51) Int. Cl. B64F 1/04; B64C 39/02; B64F 1/22

(52) U.S. Cl. CPC B64F 1/04; B64C 39/024; B64C 2201/127; B64C 2201/08; B64C 2201/208; B64F 1/22

(57) ABSTRACT

A method for deploying a drone including transporting a drone from a first location to a second location with a vehicle and supplying electricity from the vehicle to the drone while the drone is being transported. A launch command can be initiated from within the vehicle to direct the drone to ascend and hover above the vehicle. The drone can be transported in a drone port mounted to the vehicle.

### TECHNICAL FIELD

This patent application is directed to vehicle mounted drones, and more specifically, to drone ports, drones, and integrated communication systems that provide efficient situational awareness.

### BACKGROUND

In typical emergency response situations, dispatchers at emergency call centers (also referred to as computer-aided dispatch centers) receive a call related to the emergency and thereafter respond to the emergency by dispatching response units (generally termed as first responders) to the location of the emergency. However, the call related to the emergency often provides very little information about the emergency. As a result, the dispatcher's knowledge of the emergency is limited to the “description” of the emergency provided in the call. Thus, there exists a need for a new perspective that can help in determining how to use resources effectively in responding to emergency situations.

### BRIEF DESCRIPTION OF THE DRAWINGS

The drone ports, drones, and integrated communication systems described herein may be better understood by referring to the following Detailed Description in conjunction with the accompanying drawings, in which like reference numerals indicate identical or functionally similar elements:

FIG. 1 is a diagrammatic representation of a drone port, drone, and an integrated communication system according to a representative embodiment;

FIG. 2 is an isometric view of the drone port shown in FIG. 1, as viewed from the front;

FIG. 3 is an isometric view of the drone port shown in FIGS. 1 and 2, as viewed from the rear;

FIG. 4 is an isometric view of the drone shown in FIG. 1, as viewed from above;

FIG. 5 is an isometric view of the drone shown in FIGS. 1 and 4, as viewed from below;

FIG. 6 is a schematic diagram illustrating an example of a drone port circuit, in accordance with various aspects of the present disclosure; and

FIG. 7 is a schematic diagram illustrating an example of a drone circuit, in accordance with various aspects of the present disclosure.

The headings provided herein are for convenience only and do not necessarily affect the scope of the embodiments. Further, the drawings have not necessarily been drawn to scale. For example, the dimensions of some of the elements in the figures may be expanded or reduced to help improve the understanding of the embodiments. Moreover, while the disclosed technology is amenable to various modifications and alternative forms, specific embodiments have been shown by way of example in the drawings and are described in detail below. The intention, however, is not to unnecessarily limit the embodiments described. On the contrary, the embodiments are intended to cover all modifications, combinations, equivalents, and alternatives falling within the scope of this disclosure.

### DETAILED DESCRIPTION

Various examples of the devices introduced above will now be described in further detail. The following description provides specific details for a thorough understanding and enabling description of these examples. One skilled in the relevant art will understand, however, that the techniques and technology discussed herein may be practiced without many of these details. Likewise, one skilled in the relevant art will also understand that the technology can include many other features not described in detail herein. Additionally, some well-known structures or functions may not be shown or described in detail below so as to avoid unnecessarily obscuring the relevant description.

The terminology used below is to be interpreted in its broadest reasonable manner, even though it is being used in conjunction with a detailed description of some specific examples of the embodiments. Indeed, some terms may even be emphasized below; however, any terminology intended to be interpreted in any restricted manner will be overtly and specifically defined as such in this section.

Disclosed herein is a vehicle mounted drone port, drone, and integrated communication system. In some embodiments, the drone port can be mounted to an emergency vehicle (e.g., police cruiser). An autonomous drone can reside in the drone port for transport therein. The drone can be charged from the vehicle power system (e.g., battery and alternator). The drone can be powered during transport such that the drone's GPS and other flight systems are current with position information allowing the drone to be quickly deployed in emergency situations. The drone can be deployed via an application loaded onto the vehicle communication system (e.g., police laptop) and/or a dedicated button. Once deployed, the drone provides a camera feed back to the vehicle. In some embodiments, the camera feed can be distributed via the FirstNet PS-LTE broadband network. The disclosed technology can be used in conjunction with systems for responding to emergency situations, such systems being described in U.S. patent application Ser. No. 15/978,060 (Atty. Docket 127465-8002.US01), filed May 11, 2018, the disclosure of which is hereby incorporated by reference in its entirety.

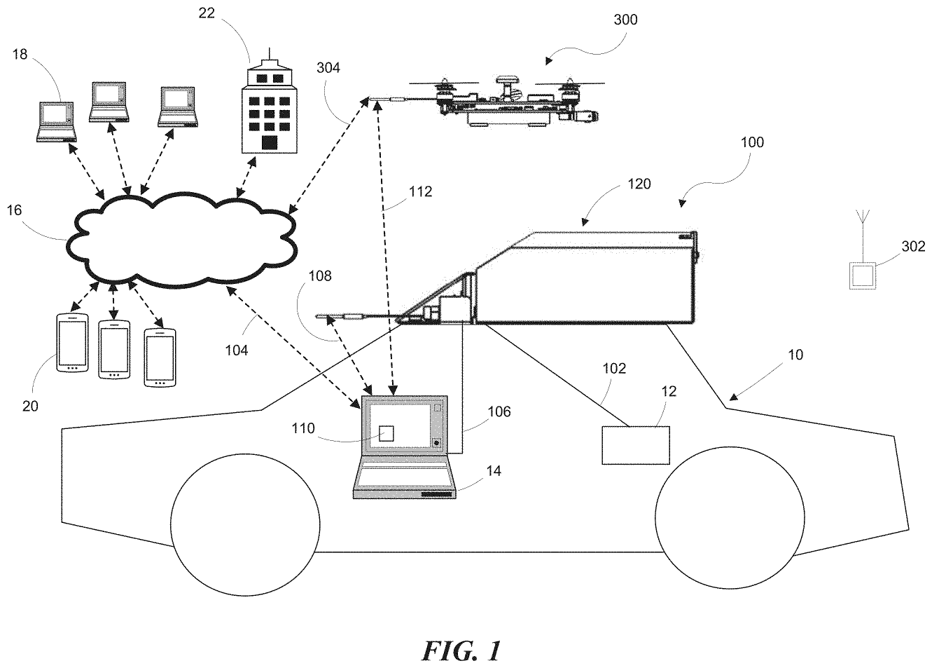

As shown in FIG. 1, the disclosed drone port 100 can be mounted to a vehicle 10, such as a police cruiser, ambulance, rescue vehicle, boat or other movable platform. An autonomous drone 300 can reside in the drone port 100 for transport therein. In the illustrated embodiment, the drone port 100 is connected to the vehicle's battery 12 via a suitable cable 102. The cable 102 can be routed through the vehicle's trunk, hood, window, or can be routed through a hole in the body work, such as the roof. The doors 120 of the drone port 100 can be controlled by a computer located in the vehicle, such as laptop computer 14. The laptop 14 can communicate with the drone port 100 through a wired connection 106 or a wireless connection 108. In some embodiments, the laptop 14 can be loaded with an application 110 programmed to operate the drone port doors 120 and communicate with the drone 300 via a wireless connection 112. In some embodiments, the laptop 14 can have a dedicated button programmed to open the drone port doors 120 and launch the drone 300. In some embodiments, the drone 300 is controlled with a remote controller 302. The remote controller 302 can also include a button for opening the drone port doors 120.

Once the drone 300 is launched from the drone port 100, the drone 300 can send date including images, sound, and/or a video feed, for example, to the laptop computer 14 via the wireless connection 112. The video feed, for example, can then be shared via a wireless connection 104 between the laptop computer 14 and a network 16. The video feed can then be distributed via the network 16 to other devices, such as police laptops 18, mobile hand held devices 20, and one or more command centers 22, such as a police dispatch or command station and/or a fire and rescue command station. In some embodiments, the drone 300 can communicate directly with the network 16 via a wireless connection 304. In some embodiments, the network 16 can comprise the FirstNet PS-LTE broadband network (e.g., a portion of the Band 14 spectrum). The FirstNet PS-LTE broadband network, established by the National Telecommunications and Information Administration (NTIA), provides first responders with a high-speed, broadband network dedicated to public safety. In some embodiments, camera data is transmitted on a 5 GHz channel, control data is transmitted on a 2.4 GHz channel, and telemetry data is transmitted on a 900 MHz channel.

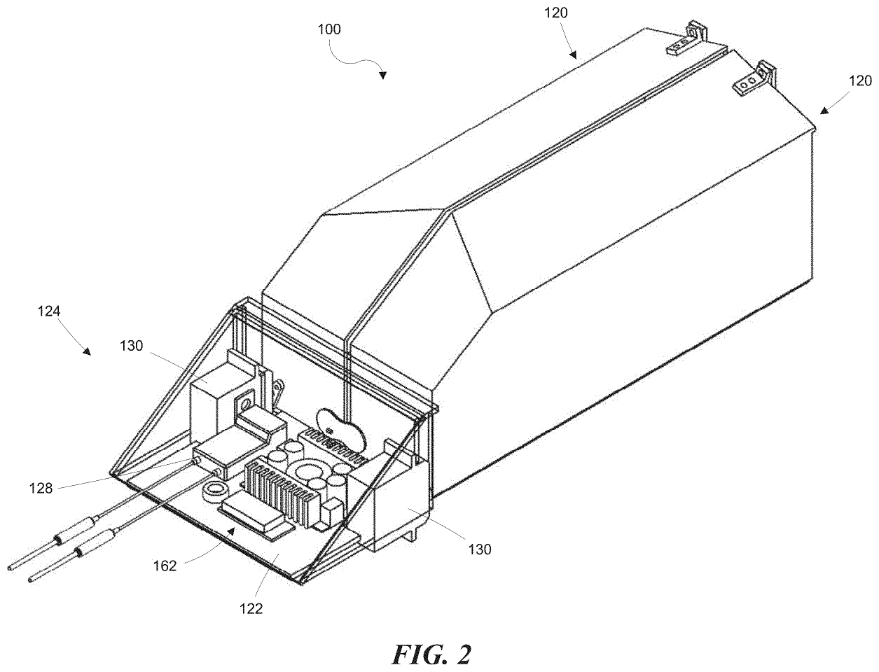

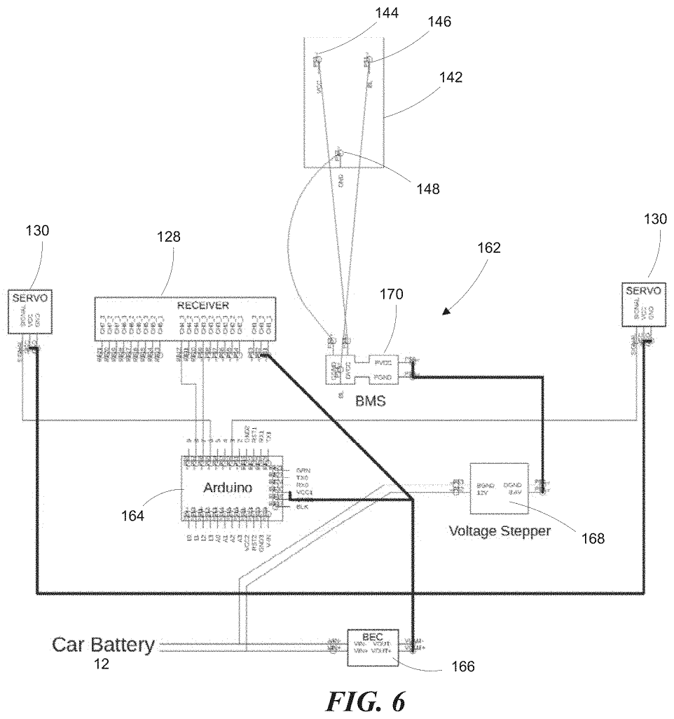

As shown in FIG. 2, the drone port 100 can include a base platform 122 configured to carry an electronics module 124 and the doors 120, which house a landing pad area for receiving and launching the drone 300 (FIG. 1). The electronics module 124 can house various power and control components 162, such as those shown in FIG. 6. For example, the electronics module 124 can house a communication transmitter/receiver 128 and a pair of servos 130 positioned to open and close the doors 120. In some embodiments, the electronics module 124 and doors 120 are configured to be aerodynamic when positioned on the roof of a vehicle. For example, an upper surface of the electronics module 124 is angled with respect to the base platform 122 and a front portion of each door 120 is similarly angled. In some embodiments, the drone port 100 can be attached to the vehicle 10 (FIG. 1) via a roof rack system, suitable hardware (e.g., bolts, screws, and/or nuts), magnets, and/or suction cups, for example.

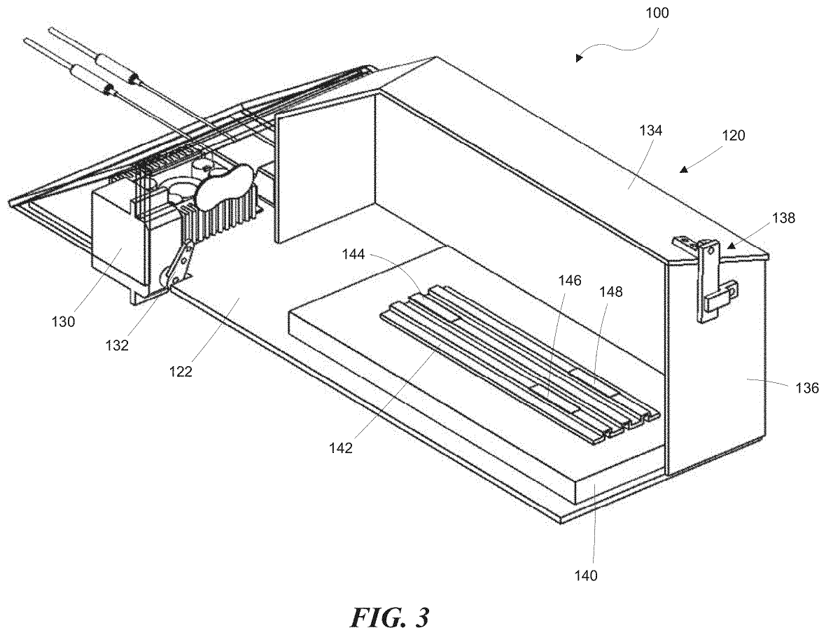

With further reference to FIG. 3, each servo 130 can pivot a corresponding drone port door 120 between an open and a closed position via a servo arm 132 connected between the servo 130 and the door 120. Each drone port door 120 can include a main door portion 134 and a secondary door portion 136. The entire door 120 or just the main door portion 134 can be pivoted open to deploy the drone 300 (FIG. 1). The secondary door portion 136 can be manually opened separately from the main door portion 134 to facilitate manually inserting the drone into the interior of the doors 120. The main door portion 134 and the secondary door portion 136 can be releasably connected to each other with latch assembly 138. The drone port doors 120 can house a landing pad 140 which in turn supports a charging rail 142. In some embodiments, the landing pad 140 is comprised of a foam material to protect the drone 300 (FIG. 1) from vibration during transport. The charging rail 142 can have terminals 144, 146, and 148 positioned to mate with corresponding terminals on the drone 300 for charging the drone's battery. The charging rail 142 can comprise an insulating material (e.g., plastic) with three ribs and two corresponding grooves. The terminals 144, 146, and 148 can comprise conductive (e.g., copper) tape positioned on the ribs as shown.

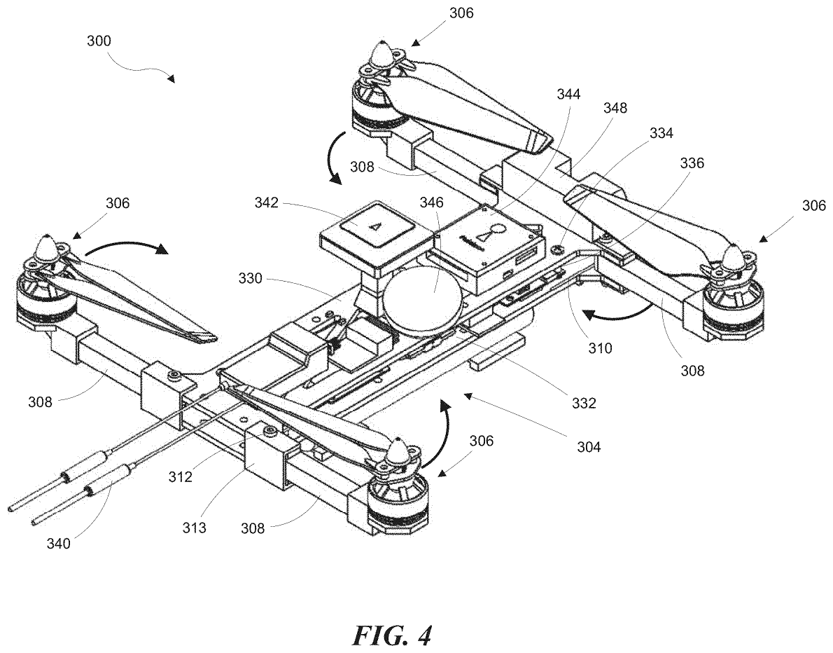

As shown in FIG. 4, the drone 300 can include an airframe 304 and four thrust assemblies 306. Each thrust assembly 306 can include a motor and propeller positioned on a corresponding arm 308. In some embodiments, the arms 308 are foldable with respect the airframe 304 by rotating them inward as indicated. In some embodiments, each arm 308 can be biased toward an extended position, as shown in the figure, by an associated torsion spring 310. In some embodiments, the drone 300 can include a latch for each arm 308 to maintain the arm in a folded position. In some embodiments, the arms 308 are held in the folded position by the doors 120. The arms 308 can be manually folded and then the drone 300 can be placed into the drone port 100 through the secondary door portions 136 (FIG. 3). When the doors 120 are rotated to an open position, the arms 308 move to the extended position.

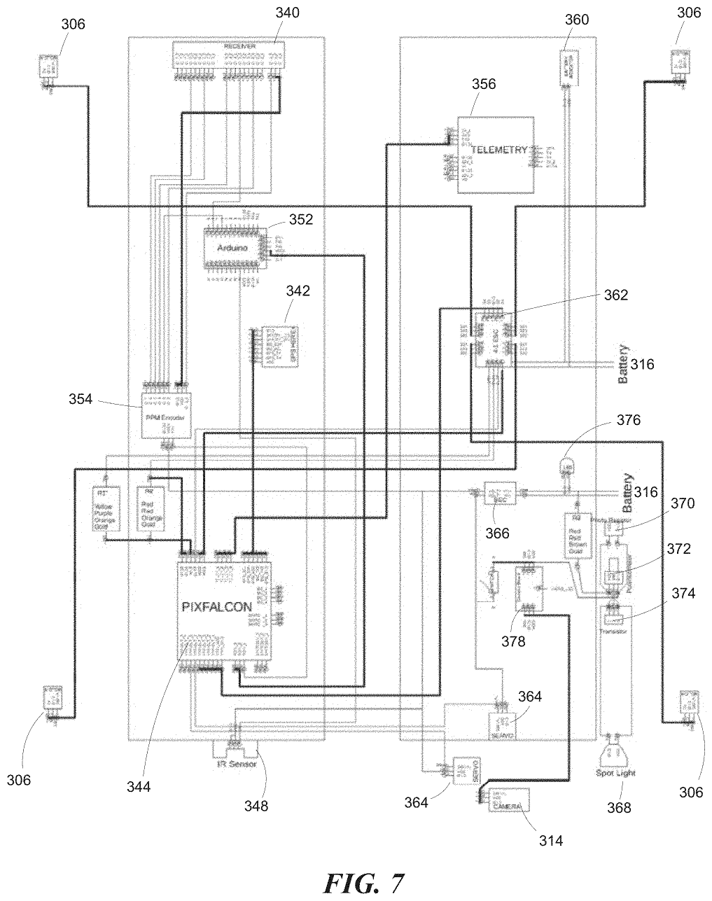

The airframe 304 can comprise a pair of spaced apart frame plates 330 and 332. The frame plates 330 and 332 can be fastened together with suitable hardware, such as screws 334. A spacer tube 336 can be positioned around each screw 334 and between the plates 330 and 332 to maintain the spacing between the plates. Each arm 308 can be pivotably attached between the frame plates 330 and 332 with screws 312. In some embodiments, a reinforcement bracket 313 is positioned adjacent the pivot screw 312 in order to reinforce the frame 304 and to limit rotation of the arm 308. The airframe 304 can support the necessary electronics, such as those shown in FIG. 7, on top of the frame, below the frame (e.g., battery), and between the frame plates 330 and 332. For example, upper frame plate 330 can carry a communication transmitter/receiver 340, a GPS unit 342, an antenna 346, a flight controller 344, and an IR sensor 348, among other components.

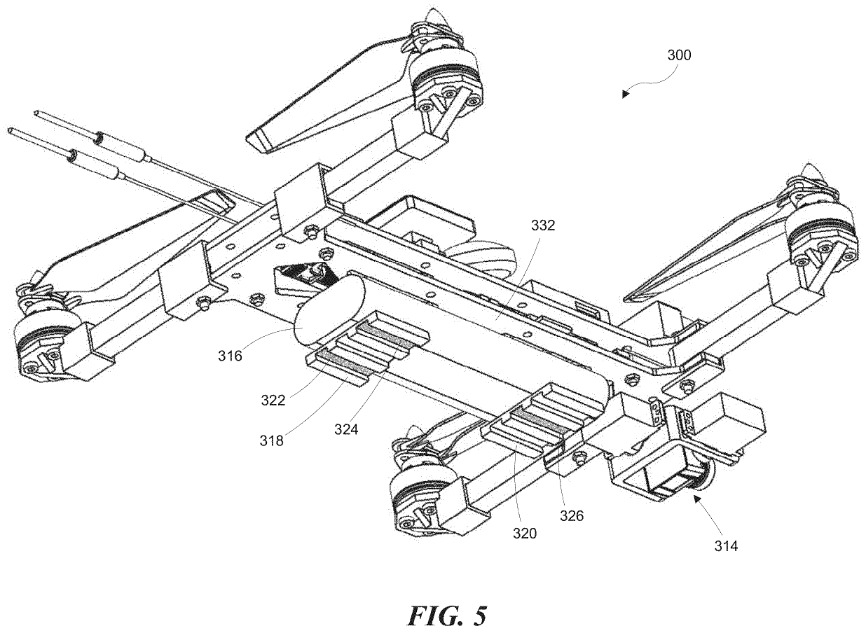

As shown in FIG. 5, a battery 316 and a camera assembly 314 can be attached to the lower frame plate 332. The battery 316 can carry a pair of charging blocks 318 and 320. Each charging block 318 and 320 includes a plurality of alternating groves and ribs positioned to mate with corresponding grooves and ribs of the drone port charging rail 142 (FIG. 3). In the depicted embodiment, the charging block 318 includes a pair of terminals 322 and 324 positioned to mate with corresponding terminals 146 and 148 on the charging rail 142. The charging block 320 includes a terminal 326 positioned to mate with terminal 144 on the charging rail 142. Having three terminals on the battery can allow access to each cell of the battery for proper charging.

As shown in FIG. 6, current from car battery 12 flows into drone port processor 164 through battery eliminator circuit (BEC) 166 to receiver 128. An example of drone port processor 164 can be the ARDUINO processor. Drone port processor 164 is configured to run software that controls various operations of multiple electrical and mechanical loads located in the drone port. For example, the operations can be in connection with launching/landing of the drone, charging the drone, processing video/image, audio data (or, otherwise any type of data captured by the drone) and calibrating the drone's components (if necessary). Drone port processor 164 also controls the operations of a pair of servos 130 which open and close the doors of the drone port. In some embodiments, drone port processor receives ambient weather (in or around the drone port) from external weather sensors such as a barometer, a thermometer, an anemometer or otherwise any mechanical or electrical weather equipment.

The BEC 166 distributes electrical power from car battery 12 to multiple electronic devices and functions as a regulated DC power supply (e.g., 5 V). In some embodiments, a single BEC (such as BEC 166) can be sufficient. Two or more BECs provide redundancy in avoiding complete breakdown.

Car battery 12 also provides electrical power to voltage stepper 168. Voltage stepper 168 conveys the electrical power to Battery Management System (BMS) 170. BMS 170 is essentially a “smart” (including one or more built-in processors) battery pack which can electronically communicate one or more battery-related parameters such as (but not limited to) voltage, current, temperature, faults, capacity used, energy stored, discharge rate, etc. to components that are external to BMS 170. For example, BMS 170 periodically, intermittently, or on-request can communicate electrical parameters to the external world. During charging, BMS 170 monitors the voltage at terminals 144, 146, 148 and terminates (“shuts off”) charging when charging is complete. Terminals 144, 146, and 148 positioned on charging rail 148 mate with corresponding terminals on the drone for charging the drone's battery.

FIG. 7 shows a schematic block diagram of various circuit components of the representative drone of FIGS. 4 and 5. For example, FIG. 7 illustrates multiple electrical and mechanical components connected to main processor 344. (Processor 344 is referred to herein as “main” processor because of the presence of at least another “secondary” processor (e.g., processor 352 shown in the schematic in FIG. 7). Main processor 344 can be a flight controller that controls a significant portion of a drone's operations during take-off, landing, and in-flight. Main processor 344 communicates telemetry information to the external world via telemetry unit 356. An example of main processor 344 can be Pixfalcon.

FIG. 7 shows a main processor 344 coupled to IR sensor 348 for capturing vision information external to the drone. For example, IR sensor 348 can capture imagery indicating an approaching aircraft, processes the captured imagery, and informs main processor 344 of obstacles in the drone's flight path. In some embodiments, IR sensor 348 can capture imagery of ground-based obstacles.

In addition to main processor 344, FIG. 7 shows that the drone 300 also includes a secondary processor 354 that provides additional functionality. An example of secondary processor 354 can be the ARDUINO processor. Besides providing redundancy in events when main processor 344 fails, secondary processor 352 can process video/image, audio, environment data, or otherwise any data captured by the drone. For example, FIG. 7 shows secondary processor receiving thermal and/or optical (RBG) video data captured by IR sensor 348 and camera 314, which can be further sent to main processor 344. This would enable main processor 344 to have access to the camera data captured by camera 314 and processed by camera board 378. Camera 314 can capture data when the drone is taking off, in-flight, or when it is landing. Camera 314 is attached to a gimbal to provide 60-degree movement along each axes. The gimbal is controlled by servos 364.

The drone obtains GPS information (e.g., from the drone port) via at least one GPS receiver/compass. In some embodiments, one GPS receiver 342 can suffice. An example of GPS receiver 342 can be the Here+RTK GPS/Compass. In some embodiments, GPS receiver 342 derives GPS signals from a satellite to identify the drone's location. Based on the received signal and feedback correction signal received through telemetry unit 356, the drone can further enhance the accuracy of its location. This continuous feedback of error estimation can advantageously result in fine precision in the drone's location information, e.g., providing an accuracy of a few centimeters.

In some embodiments, the drone can be integrated into the national airspace system by using a receiver 340 (which can also function as a transmitter) for identifying airplanes and other drones in the drone's flight path. The drone can periodically or intermittently communicate with a remote transceiver of the FAA (or, generally aviation authorities of jurisdictions) via transceiver 340. In some embodiments, the drone can include a unique identifier. Information exchanged between transceiver 340 and the remote ADS-B transceiver, for example, can allow the drone to identify itself, using the unique identifier, to other objects in its flight path and also obtain information about other objects in its flight path. Transceiver 340 is connected to PPM encoder 354. The PPM encoder 354 is a signal converter which converts multiple Pulse Width Modulated (PWM) signals into a single-wire Pulse Position Modulation (PPM).

The battery 316 provides power for operating the mechanical and electrical parts of the drone. In some embodiments, the battery comprises two cells. Under normal operating conditions (i.e., no failure) both cells can be used, working in parallel. The charge remaining in the battery is shown by battery indicator 360. Battery 316 feeds electrical power to ESC 362 which controls the power flowing to each of the servos 306. Main processor 344 can monitor the temperature, speed, input power, output power and other parameters of each servo 306 via ESC 362. BEC 366 distributes electric power from battery 316 to multiple electronic peripherals and function as a regulated DC power supply (e.g., 5 V). In some embodiments, a single BEC can be sufficient. Two or more BECs provide redundancy in avoiding complete breakdown.

Battery 316 also provides power flowing to external lighting such as one or more LEDs 376 and spot light 368 (via photo resistor 370, potentiometer 372, and transistor 374).

In operation, the drone 300 can be charged from the vehicle's power system (e.g., battery and alternator). The drone 300 can be powered during transport such that the drone's GPS 342 and other flight systems are current with position information allowing the drone 300 to be quickly deployed in emergency situations. The drone 300 can be launched by pressing a dedicated button on the laptop computer 14, a button on remote controller 302, or via the application 110. In either case, the drone port 100 receives a command to open the drone port doors 120 and the drone 300 receives a command to initiate take-off. Once the drone port doors 120 are opened, the drone 300 can ascend vertically (e.g., 50 feet) above the vehicle 10 to relay camera footage to the laptop computer 14 and/or the network 16. In some embodiments, the drone 300 can then follow the vehicle 10. In some embodiments, the drone 300 navigates with one or more fiducial marks, such as an April Tag, positioned on the vehicle 10 or on the drone port 100.

In some implementations, the drone 300 can land in the drone port 100. In other implementations the drone 300 can land near the vehicle and be manually placed into the drone port 100. In some embodiments, the drone port 100 can be in the form of a protective case sized to contain the drone and still fit within the vehicle (e.g., the trunk).

The disclosed technology allows a drone to be transported to a location and immediately deployed to provide feedback to users on the ground. This technology is therefore, useful in emergency situations, law enforcement situations, search and rescue operations, and military applications, to name a few. For example, a police officer can drive to the area of a pursuit or standoff situation and deploy the drone to provide an immediate aerial view that can be provided to multiple officers in the area. In another implementation, the drone and drone port can be used with a water craft (e.g., boat) for search and rescue operations. Having an elevated vantage point on the water can make finding a person in the water more likely, particularly in rough water. The disclosed vehicle mounted drone port and drone can also facilitate inspection operations in remote areas, such as oil well, powerline, pipeline, and cell tower inspection.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

What is claimed is:

1. A method for deploying a drone, the method comprising:
transporting a drone from a first location to a second location with a vehicle;
supplying electricity from the vehicle to the drone while the drone is being transported; and
initiating a launch command from within the vehicle directing the drone to ascend and hover above the vehicle.

2. The method of claim 1, wherein the drone is transported in a drone port mounted to the vehicle.

3. The method of claim 2, wherein initiating the launch command further comprises opening one or more doors on the drone port.

4. The method of claim 1, further comprising moving the vehicle after initiating the launch command and causing the drone to follow the moving vehicle.

5. The method of claim 1, further comprising receiving video data from the drone.
